(19) United States
(12) Patent Application Publication
(10) Pub. No.: US 2021/0344204 A1
(43) Pub. Date: Nov. 4, 2021

(54) POWER STORAGE DEVICE AND CHARGING METHOD

(71) Applicant: FDK CORPORATION, Tokyo (JP)

(72) Inventor: Shun Mochizuki, Tokyo (JP)

(21) Appl. No.: 17/268,912

(22) PCT Filed: Jun. 14, 2019
(86) PCT No.: PCT/JP2019/023595

§ 371 Date: Feb. 16, 2021

(30) Foreign Application Priority Data
Sep. 7, 2018 (JP) 2018-168047

(51) Int. Cl. H02J 7/00

(52) U.S. Cl. CPC H02J 7/0019; H02J 7/007182

(57) ABSTRACT

A power storage device 1 includes first power storage unit BBU1 to seventh power storage unit BBU7 connected in series and a control unit 10 for monitoring each unit voltage and controlling each of the power storage units, each power storage unit BBU 1-7 includes a power storage portion BAT and a charge switch SW_{C} connected in series between charge/discharge terminals T and a bypass switch SW_{B} providing a bypass between the charge/discharge terminals T, and for the respective power storage units connected in series, the control unit 10 equalizes the unit voltages by individually setting a charging mode in which the bypass switch SW_{B} is controlled to be set to OFF while the charge switch SW_{C} is controlled to be set to ON to charge the power storage portion BAT with a constant current, and a bypass mode in which the bypass switch SW_{B} is controlled to be set to ON while the charge switch SW_{C} is controlled to be set to OFF to stop charging of the power storage portion BAT.

### CROSS-REFERENCE TO RELATED APPLICATION(S)

This application is the national phase of PCT Application No. PCT/JP2019/023595 filed on Jun. 14, 2019, which in turn claims priority to Japanese Application No. 2018-168047 filed on Sep. 7, 2018, both of which are incorporated by reference in their entireties.

### BACKGROUND

### Technical Field

The present disclosure relates to a power storage device and a charging method.

### Background Art

A power storage system such as an uninterruptible power supply device can supply electric power to a load device for a certain period of time even during power outage, and thus it has been widely used as a backup power supply for BCP countermeasures in the event of a disaster, for example. In normal times when AC power is supplied from a commercial power source to a load device, the power storage system branches the AC power to receive power, and converts the received power into DC power, and then charges a storage battery by a charging circuit. When power outage occurs, the power storage system maintains power supply to the load device by converting the power charged in the storage battery into AC power with an inverter and supplying the AC power to the load device.

The power storage system as described above can be easily managed by configuring the power storage system as a power storage unit including a plurality of storage batteries, and it is further adaptable to a load device requiring a high voltage by connecting a plurality of power storage units in series. However, in such a power storage system, a charging voltage is applied to the whole of the plurality of power storage units connected in series at the time of charging, and when variation occurs among respective unit voltages of the plurality of power storage units, from the viewpoint of preventing overcharging, it is necessary to terminate charging at the time point when any unit voltage has reached full charge. Therefore, the power storage system as described above may be restricted to perform charging and discharging with only a power capacity smaller than the originally designed capacity.

In order to suppress the variation in unit voltage among the plurality of power storage units, a battery system is constructed in a prior art described in Patent Document 1 by a storage battery group A including a plurality of storage batteries connected in series and one storage battery B having a lower capacity than the storage battery group A, which are connected in series. As a result, the prior art of Patent Document 1 prevents all the storage batteries included in the storage battery group A from being overcharged and overdischarged by managing SOC (State of Charge) of the storage battery group A within a certain range.

### PRIOR ART DOCUMENT

### Patent Document

Patent Document 1: Japanese Patent Laid-Open No. 2010-9840

### SUMMARY

However, the above-mentioned prior art is intended to suppress occurrence of overcharging and overdischarging by equalizing the SOCs of the plurality of storage batteries, but a configuration thereof for that purpose limits the power capacity which can be charged in the storage batteries included in the battery system.

An object of the present disclosure, which has been made in view of such a situation, is to provide a power storage device capable of suppressing reduction in rechargeable power capacity while equalizing the capacities of a plurality of power storage units connected in series during charging of the plurality of power storage units, and a method of charging the power storage device.

In order to achieve the above object, an aspect of the present disclosure is directed to a power storage device comprising: a plurality of power storage units connected in series; and a control unit for monitoring a unit voltage of each of the plurality of power storage units and controlling each of the plurality of power storage units, wherein each of the power storage units includes an power storage portion and a charge switch which are connected to each other in series between charge/discharge terminals, and a bypass switch providing a bypass between the charge/discharge terminals, and for the plurality of power storage units to be charged in series, the control unit individually sets a charging mode in which the power storage portion is charged with a constant current by controlling the bypass switch to be set to OFF while controlling the charge switch to be set to ON, and a bypass mode in which the charging of the power storage portion is stopped by controlling the bypass switch to be set to ON while controlling the charge switch to be set to OFF, thereby equalizing the unit voltages.

According to the present disclosure, there can be provided a power storage device capable of suppressing reduction in rechargeable power capacity while equalizing capacities of a plurality of power storage units connected in series during charging of the plurality of power storage units, and a method of charging the power storage device.

### BRIEF DESCRIPTION OF THE DRAWINGS

FIG. 1 is a circuit diagram of a backup power supply using a power storage device according to the present disclosure.

FIG. 2 is a circuit diagram showing a configuration of the power storage device according to the present disclosure.

FIG. 3 is a graph showing changes in charging voltage, the number of charging units, and a total voltage during charging of the power storage device according to the present disclosure.

### DETAILED DESCRIPTION

Embodiments of the present disclosure will be described hereunder in detail with reference to the drawings. Note that the present disclosure is not limited to the contents described below, and any modification and implementation may be made without changing the subject matter thereof. Further, all the drawings used for describing the embodiments schematically show components, and are subjected to partially emphasis, enlargement, reduction, or omission in order to deepen the understanding of the components. Therefore, the drawings may not accurately represent the scales, shapes and the like of the components.

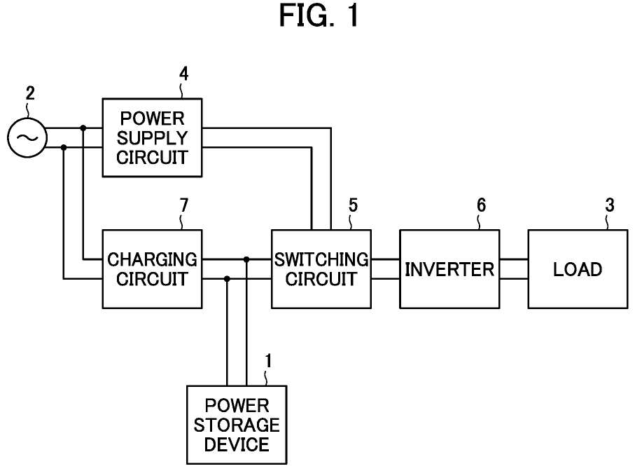

FIG. 1 is a circuit diagram of a backup power supply using a power storage device 1 according to the present disclosure. More specifically, FIG. 1 is a circuit diagram illustrating the configuration of a backup power supply provided in a power supply path from a commercial power source 2 to a load 3.

As describing a detailed configuration later, the power storage device 1 is a so-called uninterruptible power system (UPS) that can be charged with power supplied from the commercial power source 2 and enables power supply to the load 3 to be continued by discharging under power outage of the commercial power source 2.

In the present embodiment, power of AC100V output from the commercial power source 2 is converted to DC380V in a power supply circuit 4, and supplied to a switching circuit 5. In normal times when no power outage occurs, the power of DC380V supplied to the switching circuit 5 is reconverted to AC100V in an inverter 6, and output to the load 3.

Further, the power of AC100V output from the commercial power source 2 is converted into DC power in a charging circuit 7, and also converted into a voltage required by the power storage device 1 to be used for charging the power storage device 1.

When power outage occurs in the commercial power source 2, the power storage device 1 outputs DC power to the inverter 6 via the switching circuit 5. As a result, the power of DC380V output from the power storage device 1 is reconverted to AC100V in the inverter 6 and output to the load 3. In other words, the switching circuit 5 outputs the power input from the power supply circuit 4 to the inverter 6 in normal times when no power outage occurs, and outputs the power input from the power storage device 1 to the inverter 6 when power outage occurs, whereby the power supply source is switched.

Note that the configuration of the backup power supply using the power storage device 1 of the present disclosure is not limited to the circuit configuration described above, and various changes can be made depending on conditions such as applicable equipment, etc.

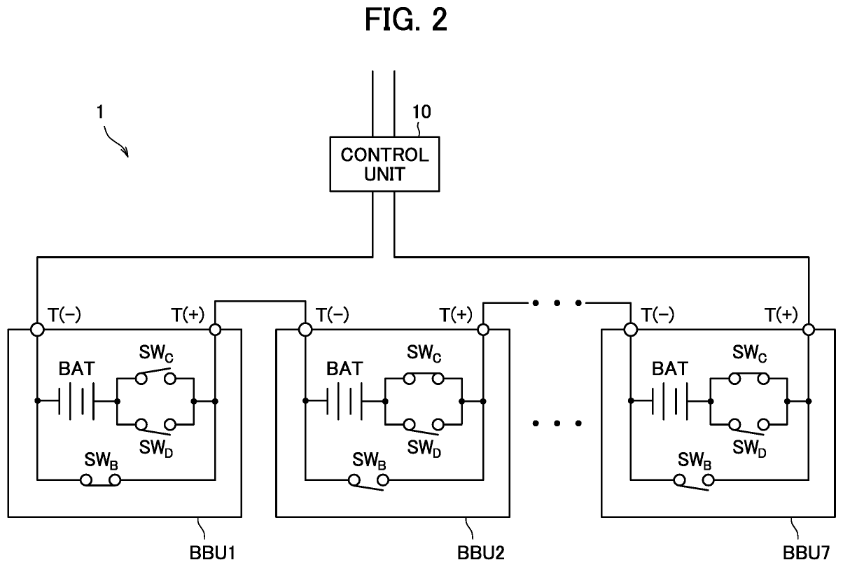

A configuration of the power storage device 1 will be described in more detail. FIG. 2 is a circuit diagram showing the configuration of the power storage device 1 according to the present disclosure.

The power storage device 1 includes a first power storage unit BBU1 to a seventh power storage unit BBU7 which are connected in series, and a control unit 10. Here, a configuration including power storage units of the series connection number N_{TOTAL}=7 is illustrated in the present embodiment. However, the number of power storage units included in the power storage device 1 is not limited to this number, and the number is appropriately adjusted so as to obtain an output voltage required for the load 3.

The first power storage unit BBU1 has charge/discharge terminals T(−) and T(+) formed therein, and includes an power storage portion BAT and a charge switch SW_{C} that are connected in series between the charge/discharge terminals in the first power storage unit BBU1. Further, the first power storage unit BBU1 includes a discharge switch SW_{D} which is connected in parallel with the charge switch SW_{C}. Further, the first power storage unit BBU1 has a bypass path formed between the charge/discharge terminals, and a bypass switch SW_{B} is provided in the bypass path.

Here, the power storage portion BAT is made up of a plurality of battery cells each made of, for example, a nickel metal hydrogen battery or a nickel cadmium battery, which are connected in series. Further, the charge switch SW_{C}, the discharge switch SW_{D}, and the bypass switch SW_{B} are composed of switching elements operating at high speed, such as MOSFETs (Metal-Oxide-Semiconductor Field-Effect Transistors) and IGBTs (Insulated Gate Bipolar Transistors).

The charge switch SW_{C} is controlled to be set to ON, the discharge switch SW_{D} is controlled to be set to OFF, and the bypass switch SW_{B} is controlled to be set to OFF, whereby the first power storage unit BBU1 is set to a charging mode in which the power storage portion BAT is charged with a charging voltage applied between the charge/discharge terminals. Further, the charge switch SW_{C} is controlled to be set to OFF, the discharge switch SW_{D} is controlled to be set to ON, and the bypass switch SW_{B} is controlled to be set to OFF, whereby the first power storage unit BBU1 is set to a discharging mode in which the voltage of the power storage portion BAT as a unit voltage is output between the charge/discharge terminals.

Here, the configurations of a second power storage unit BBU2 to the seventh power storage unit BBU7 are the same as the configuration of the first power storage unit BBU1 described above, and thus detailed description thereof will be omitted.

The control unit 10 is a so-called BMS (Battery Management System) that includes, for example, a well-known microcomputer control circuit and controls charging/discharging of the power storage device 1. When charging the power storage device 1, the control unit 10 receives power from the charging circuit 7, and applies a charging voltage V_{C} between the charge/discharge terminal T(−) of the first power storage unit BBU1 and the charge/discharge terminal T(+) of the seventh power storage unit BBU7. Further, when discharging the power storage device 1, the control unit 10 supplies the switching circuit 5 with a total voltage V_{TOTAL} between the charge/discharge terminal T(−) of the first power storage unit BBU1 and the charge/discharge terminal T(+) of the seventh power storage unit BBU7.

More specifically, the control unit 10 is configured to be capable of monitoring the respective unit voltages of the first power storage unit BBU1 to the seventh power storage unit BBU7, and individually controlling the charge switch SW_{C}, the discharge switch SW_{D}, and the bypass switch SW_{B} of each of the power storage units.

When charging the first power storage unit BBU1 to the seventh power storage unit BBU7 in series, the control unit 10 can set a bypass mode in which charging for a specific power storage unit is stopped. More specifically, for example, when setting the first power storage unit BBU1 to the bypass mode, the control unit 10 controls the charge switch SW_{C}, the discharge switch SWD and the bypass switch SW_{B} of the first power storage unit BBU1 to be set to OFF, OFF and ON respectively, whereby the charge/discharge terminals of the first power storage unit BBU1 are short-circuited to prohibit the power storage portion BAT from being charged. In this case, in the series charging of the respective power storage units, the second power storage unit BBU2 to the seventh power storage unit BBU7 are charged, whereas the first power storage unit BBU1 is excluded from the series charging.

Subsequently, a charging method for serially charging the first power storage unit BBU1 to the seventh power storage unit BBU7 of the power storage device 1 will be described.

The power storage device 1 can arbitrarily set a timing of charging in a case where the total voltage V_{TOTAL}, which is the total of the unit voltages of the first power storage unit BBU1 to the seventh power storage unit BBU7, drops to a predetermined threshold value or less, in a case of recovering from power outage, and the like. In the following description, it is assumed that charging is started from a state where the total voltage V_{TOTAL} drops to a discharge termination voltage V_{CUTOFF}. Further, the total voltage V_{TOTAL} in the present embodiment will be described on the assumption that the discharge termination voltage V_{CUTOFF} is 265 V and a charging upper limit voltage is 380 V.

Further, the control unit 10 continuously monitors the voltage of each of the power storage portions BAT of the first power storage unit BBU1 to the seventh power storage unit BBU7 at least during charging of the power storage device 1 (voltage monitoring step). Further, the control unit 10 performs the series charging of the respective power storage units while the number N_{C} of power storage units to be set to the charging mode is controlled to be equal to a minimum natural number satisfying N_{C}≥V_{CUTOFF}×N_{TOTAL}/V_{TOTAL} (series charging step).

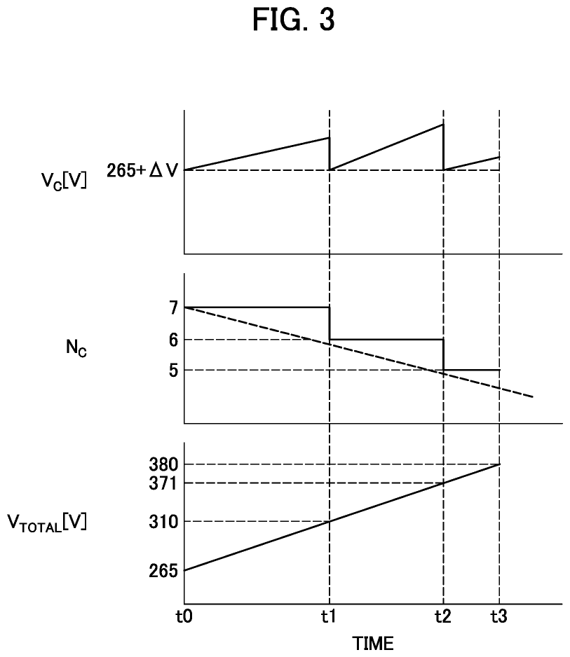

FIG. 3 is a graph showing changes in the charging voltage V_{C}, the number of charging units N_{C}, and the total voltage V_{TOTAL} during charging of the power storage device 1 according to the present disclosure. The horizontal axis of FIG. 3 represents an elapsed time from a charging start timing t0.

At the charging start timing t0, the control unit 10 calculates the number N_{C} of power storage units to be set to the charging mode among the plurality of power storage units included in the power storage device 1, and starts the series charging. Here, the power storage device 1 sets all the power storage units to the charging mode and starts the series charging from V_{CUTOFF}×N_{TOTAL}/V_{TOTAL}=7 because the discharge termination voltage V_{CUTOFF} is equal to 265 V, the series connection number N_{TOTAL} of power storage units is equal to 7, and the total voltage V_{TOTAL} at the start time of charging is equal to 265 V.

When charging of the power storage device 1 is started, the total voltage V_{TOTAL} also increases as the charging progresses. Here, the control unit 10 controls the charging voltage V_{C} so that the charging voltage V_{C} is equal to a voltage value obtained by adding a constant potential difference ΔV to the increasing total voltage V_{TOTAL}, whereby the power storage units in the charging mode can be charged with a constant current.

When the total voltage V_{TOTAL} has reached 310 V at a timing t1, the control unit 10 sets the number N_{C} of power storage units to be set to the charging mode to 6 from V_{CUTOFF}×N_{TOTAL}/V_{TOTAL}=5.98, and sets the remaining one power storage unit to the bypass mode. At this time, in order to equalize the unit voltages of the power storage units, the control unit 10 sets, to the bypass mode, a power storage unit in which charging is most advanced (the unit voltage is high) among the first power storage unit BBU1 to the seventh power storage unit BBU7, and continues the series charging. Further, since the number of power storage units to be set to the charging mode decreases, the control unit 10 controls such that the charging voltage V_{C} returns to the discharge termination voltage V_{CUTOFF}=265 V again, and the charging voltage V_{C} increases according to the total of the unit voltages of the power storage units set in the charging mode.

Here, when there is a power storage unit to be set to the bypass mode, the unit voltage of one of the power storage units in the charging mode and the unit voltage of the power storage unit in the bypass mode may be reversed as the charging progresses. In this case, the control unit 10 can promote equalization of the unit voltages by interchanging the modes of both the power storage units.

When the total voltage V_{TOTAL} has reached 371 V at a timing t2, the control unit 10 sets the number N_{C} of the power storage units to be set to the charging mode to 5 from V_{CUTOFF}×N_{TOTAL}/V_{TOTAL}=5, and sets the remaining two power storage units to the bypass mode. At this time, in order to equalize the unit voltages of the power storage units, the control unit 10 sets, to the bypass mode, two power storage units in which the charging is most advanced among the first power storage unit BBU1 to the seventh power storage unit BBU7, and continues the series charging. Further, since the number of power storage units to be set to the charging mode decreases, the control unit 10 controls such that the charging voltage V_{C} returns to the discharge termination voltage V_{CUTOFF}=265 V again, and the charging voltage V_{C} increases according to the total of the unit voltages of the power storage units set in the charging mode.

After the timing t2, as in the case of the period from the timing t1 to the timing t2, the control unit 10 also controls such that the unit voltages are equalized by switching the power storage units set in the charging mode and the power storage units set in the bypass mode as the charging progresses. At this time, since the number of power storage units set in the bypass mode increases in the period from the timing t2 to the timing t3 as compared with the period from the timing t1 to the timing t2, the equalization control of the unit voltages can be performed more finely.

When the total voltage V_{TOTAL} has reached 380 V, which is a charging upper limit voltage, at the timing t3, the control unit 10 stops the charging on all the power storage units on the assumption that the power storage device 1 has fallen into a fully charged state. As a result, the charging on the first power storage unit BBU1 to the seventh power storage unit BBU7 is completed in a state where the difference in unit voltage among the power storage units is reduced as the series charging progresses and thus the unit voltages are equalized. Therefore, each power storage unit is suppressed from falling into an overcharged state, and has been charged until a rechargeable power capacity.

Here, the present embodiment has been described on the assumption that charging is started from a state where the total voltage V_{TOTAL} has dropped to the discharge termination voltage V_{CUTOFF}. However, when the series charging is started, for example, from a state where the total voltage V_{TOTAL} is 310 V, charging is started from a state at the timing t1 of FIG. 3 in which the six power storage units are set to the charging mode.

When power outage occurs during series charging, for all the power storage units, the control unit 10 controls the charge switches SW_{C} and the bypass switches SW_{B} to be set to OFF and controls the discharge switches SW_{C} to be set to ON, thereby setting the first power storage unit BBU1 to the seventh power storage unit BBU7 to the discharge mode all at once. As a result, even when power outage occurs during charging, the power storage device 1 can immediately output the total voltage V_{TOTAL} to the load 3, and can reduce the possibility that power being supplied to the load 3 may be interrupted momentarily.

As described above, the power storage device 1 according to the present disclosure can equalize the unit voltages by sequentially setting the power storage units to the bypass mode in the series charging of the first power storage unit BBU1 to the seventh power storage unit BBU7. Further, the power storage device 1 can more finely equalize the unit voltages by increasing the number of power storage units to be set to the bypass mode as the series charging progresses. Still further, the power storage device 1 controls the number N_{C} of the power storage units to be set to the charging mode so that the number N_{C} is equal to a minimum natural number satisfying N_{C}≥V_{CUTOFF}×N_{TOTAL}/V_{TOTAL}, whereby the power storage device 1 can increase the number of power storage units to be set to the bypass mode as early as possible and equalize the unit voltages more reliably while suppressing a charging time to be taken for full charge. Even when power outage occurs during charging, the power storage device 1 can suppress momentary interruption in the load 3 by setting the respective power storage units to the discharging mode all at once. Therefore, according to the power storage device 1 according to the present disclosure, when a plurality of power storage units connected in series is charged, it is possible to suppress reduction in the rechargeable power capacity while equalizing the capacities of the power storage units.

### EMBODIMENTS OF THE PRESENT DISCLOSURE

A first aspect of the present disclosure is a power storage device comprising a plurality of power storage units connected in series, and a control unit for monitoring a unit voltage of each of the plurality of power storage units and controlling each of the plurality of power storage units, wherein each of the power storage units includes a power storage portion and a charge switch which are connected to each other in series between charge/discharge terminals, and a bypass switch providing a bypass between the charge/discharge terminals, and for the plurality of power storage units to be charged in series, the control unit individually sets a charging mode in which the power storage portion is charged with a constant current by controlling the bypass switch to be set to OFF while controlling the charge switch to be set to ON, and a bypass mode in which the charging of the power storage portion is stopped by controlling the bypass switch to be set to ON while controlling the charge switch to be set to OFF, thereby equalizing the unit voltages.

The power storage device includes the plurality of power storage units connected in series, and these power storage units are charged in series by the control unit. Here, in each power storage unit, the power storage portion and the charge switch are connected to each other in series between the charge/discharge terminals, and the bypass switch is provided so as to bypass between the charge/discharge terminals. Therefore, each power storage unit is set to the charging mode in which the power storage portion is charged by controlling the charge switch to be set to ON and controlling the bypass switch to be set to OFF. Further, each power storage unit is set to the bypass mode in which the power storage portion is bypassed by controlling the charge switch to be set to OFF and controlling the bypass switch to be set to ON.

The control unit controls the charging voltage according to the voltage of the power storage unit set to the charging mode while individually setting each power storage unit to the charging mode or the bypass mode, whereby the unit voltages can be equalized while the respective power storage units are charged in series with a constant current. Therefore, the power storage device can reduce the possibility that only some of the power storage units may be overcharged, and can perform charging up to the upper limit of the power capacity of each power storage unit.

As a result, according to the first aspect of the present disclosure, in the charging of the plurality of power storage units connected in series, it is possible to suppress reduction in the rechargeable power capacity while equalizing the capacities of the power storage units.

A second aspect of the present disclosure is an power storage device in which, in the foregoing first aspect of the present disclosure, the control unit increases the number of power storage units to be set to the bypass mode as the charging of the plurality of power storage units progresses.

According to the second aspect of the present disclosure, in the series charging of the plurality of power storage units, the power storage device can equalize the unit voltages more finely by increasing the number of power storage units to be set to the bypass mode as the state approaches a full charge state.

A third aspect of the present disclosure is a power storage device in which, in the foregoing first or second aspect of the present disclosure, the control unit controls the number N_{C} of the power storage units to be set to the charging mode so that the number N_{C} is equal to a minimum natural number satisfying N_{C}≥V_{CUTOFF}×N_{TOTAL}/V_{TOTAL} when a discharge termination voltage of the power storage unit is represented by V_{CUTOFF}, a series connection number of the power storage units is represented by N_{TOTAL}, and a total voltage of the plurality of power storage units is represented by V_{TOTAL}.

In the series charging of the plurality of power storage units, the time required for charging can be shortened by increasing the number of power storage units to be set to the charging mode. Further, the unit voltages can be more reliably equalized by increasing the number of power storage units to be set to the bypass mode. Therefore, the power storage device can perform series charging optimizing both the merits described above by controlling the number N_{C} of the power storage units to be set to the charging mode based on the expression of N_{C}≥V_{CUTOFF}×N_{TOTAL}/V_{TOTAL}.

As a result, according to the third aspect of the present disclosure, the power storage device can increase the number of power storage units to be set to the bypass mode as early as possible while suppressing a charging time to be taken for full charge, and can more reliably equalize the unit voltages.

A fourth aspect of the present disclosure is a power storage device in which, in any one of the foregoing first to third aspects of the present disclosure, the power storage unit includes a discharge switch connected in parallel to the charge switch, and when power outage occurs during charging of the plurality of power storage units, for all the power storage units, the control unit controls the charge switches and the bypass switches to be set to OFF and controls the discharge switches to be set to ON.

According to the fourth aspect of the present disclosure, even when power outage occurs during charging, the power storage device can suppress momentary interruption in the load by setting the respective power storage units to the discharge mode all at once.

A fifth aspect of the present disclosure is a charging method that charges a plurality of power storage units connected in series, and comprises a voltage monitoring step of monitoring a unit voltage of each of the plurality of power storage units, and a series charging step of performing series charging on each of the plurality of power storage units while equalizing the unit voltages by individually setting either a charging mode in which an internal power storage portion is charged with a constant current or a bypass mode in which the internal power storage portion is bypassed to stop charging.

In the charging method according to the fifth aspect of the present disclosure, when the plurality of power storage units is charged in series, a charging mode or a bypass mode is individually set for each of the power storage units while monitoring the voltage of each unit. At this time, a charging voltage is controlled according to the voltage of the power storage unit set to the charging mode, whereby the unit voltages can be equalized while performing series charging on each power storage unit with a constant current. As a result, the charging method of the present disclosure can reduce the possibility that only some of the power storage units may be overcharged, and can perform charging up to the upper limit of the power capacity of each power storage unit. Therefore, according to the charging method according to the fifth aspect of the present disclosure, in the charging of the plurality of power storage units connected in series, the reduction in rechargeable power capacity can be suppressed while the capacities of the power storage units are equalized.

A sixth aspect of the present disclosure is a charging method in which, in the foregoing fifth aspect of the present disclosure, the number of power storage units to be set to the bypass mode is increased as the charging of the plurality of power storage units progresses in the series charging step.

According to the charging method of the sixth aspect of the present disclosure, in the series charging of the plurality of power storage units, the number of power storage units to be set to the bypass mode increases as the state approaches a full charge state, so that the unit voltages can be equalized more finely.

A seventh aspect of the present disclosure is a charging method in which, in the foregoing fifth or sixth aspect of the present disclosure, the number N_{C} of the power storage units to be set to the charging mode is controlled to be equal to a minimum natural number satisfying N_{C}≥V_{CUTOFF}×N_{TOTAL}/V_{TOTAL} in the series charging step when a discharge termination voltage of the power storage unit is represented by V_{CUTOFF}, a series connection number of the power storage units is represented by N_{TOTAL}, and a total voltage of the plurality of power storage units is represented by V_{TOTAL}.

In the series charging of the plurality of power storage units, the time required for charging can be shortened by increasing the number of power storage units to be set to the charging mode. Further, the unit voltages can be more reliably equalized by increasing the number of power storage units to be set to the bypass mode. Therefore, it is possible to perform series charging optimizing both the merits by the charging method for controlling the number N_{C} of the power storage units to be set to the charging mode based on the expression of N_{C}≥V_{CUTOFF}×N_{TOTAL}/V_{TOTAL}.

As a result, according to the charging method of the seventh aspect of the present disclosure, the number of power storage units to be set to the bypass mode can be increased as early as possible while suppressing the charging time to be taken for full charge, and the unit voltages can be equalized more reliably.

An eighth aspect of the present disclosure is a charging method in which, in any one of the foregoing fifth to seventh aspects of the present disclosure, in the series charging step, when power outage occurs during charging of the plurality of power storage units, all the power storage units are set to a discharging mode in which charging of internal power storage portions thereof is stopped to discharge the power storage portions.

According to the charging method of the eighth aspect of the present disclosure, even when power outage occurs during charging, a momentary interruption in a load can be suppressed by setting the respective power storage units to the discharging mode all at once.

### EXPLANATION OF REFERENCE SIGNS

1 power storage device
2 commercial power source
3 load
10 control unit
BBU1 to BBU7 first power storage unit to seventh power storage unit
BAT power storage portion
SW_{C} charge switch
SW_{D} discharge switch
SW_{B} bypass switch
T(+), T(−) charge/discharge terminal

1. A power storage device comprising:
a plurality of power storage units connected in series; and
a control unit for monitoring a unit voltage of each of the plurality of power storage units and controlling each of the plurality of power storage units, wherein each of the power storage units includes a power storage portion and a charge switch which are connected to each other in series between charge/discharge terminals, and a bypass switch providing a bypass between the charge/discharge terminals,
wherein, for the plurality of power storage units to be charged in series, the control unit individually sets a charging mode in which the power storage portion is charged with a constant current by controlling the bypass switch to be set to OFF while controlling the charge switch to be set to ON, and a bypass mode in which the charging of the power storage portion is stopped by controlling the bypass switch to be set to ON while controlling the charge switch to be set to OFF, thereby equalizing the unit voltages.

2. The power storage device according to claim 1, wherein the control unit increases a number of the power storage units to be set to the bypass mode as the charging of the plurality of power storage units progresses.

3. The power storage device according to claim 1, wherein the control unit controls a number N_{C} of the power storage units to be set to the charging mode so that the number N_{C} is equal to a minimum natural number satisfying N_{C}≥V_{CUTOFF}×N_{TOTAL}/V_{TOTAL} when a discharge termination voltage of the power storage unit is represented by V_{CUTOFF}, a series connection number of the power storage units is represented by N_{TOTAL}, and a total voltage of the plurality of power storage units is represented by V_{TOTAL}.

4. The power storage device according to claim 1, wherein each power storage unit includes a discharge switch connected in parallel to the charge switch, and when power outage occurs during charging of the plurality of power storage units, for all the power storage units, the control unit controls the charge switches and the bypass switches to be set to OFF and controls the discharge switches to be set to ON.

5. A charging method for charging a plurality of power storage units connected in series, comprising:
a voltage monitoring step of monitoring a unit voltage of each of the plurality of power storage units; and
a series charging step of performing series charging on each of the plurality of power storage units while equalizing the unit voltages by individually setting either a charging mode in which an internal power storage portion is charged with a constant current or a bypass mode in which the internal power storage portion is bypassed to stop charging.

6. The charging method according to claim 5, wherein, in the series charging step, a number of the power storage units to be set to the bypass mode is increased as the charging of the plurality of power storage units progresses.

7. The charging method according to claim 5, wherein, in the series charging step, a number N_{C} of the power storage units to be set to the charging mode is controlled to be equal to a minimum natural number satisfying N_{C}≥V_{CUTOFF}×N_{TOTAL}/V_{TOTAL} when a discharge termination voltage of the power storage unit is represented by V_{CUTOFF}, a series connection number of the power storage units is represented by N_{TOTAL}, and a total voltage of the plurality of power storage units is represented by V_{TOTAL}.

8. The charging method according to claim 5, wherein, in the series charging step, when power outage occurs during charging of the plurality of power storage units, all the power storage units are set to a discharging mode in which charging of internal power storage portions thereof is stopped to discharge the power storage portions.

9. The power storage device according to claim 2, wherein the control unit controls a number N_{C} of the power storage units to be set to the charging mode so that the number N_{C} is equal to a minimum natural number satisfying N_{C}≥V_{CUTOFF}×N_{TOTAL}/V_{TOTAL} when a discharge termination voltage of the power storage unit is represented by V_{CUTOFF}, a series connection number of the power storage units is represented by N_{TOTAL}, and a total voltage of the plurality of power storage units is represented by V_{TOTAL}.

10. The power storage device according to claim 2, wherein each power storage unit includes a discharge switch connected in parallel to the charge switch, and when power outage occurs during charging of the plurality of power storage units, for all the power storage units, the control unit controls the charge switches and the bypass switches to be set to OFF and controls the discharge switches to be set to ON.

11. The charging method according to claim 6, wherein, in the series charging step, a number N_{C} of the power storage units to be set to the charging mode is controlled to be equal to a minimum natural number satisfying N_{C}≥V_{CUTOFF}×N_{TOTAL}/V_{TOTAL} when a discharge termination voltage of the power storage unit is represented by V_{CUTOFF}, a series connection number of the power storage units is represented by N_{TOTAL}, and a total voltage of the plurality of power storage units is represented by V_{TOTAL}.

12. The charging method according to claim 6, wherein, in the series charging step, when power outage occurs during charging of the plurality of power storage units, all the power storage units are set to a discharging mode in which charging of internal power storage portions thereof is stopped to discharge the power storage portions.
